(19) United States
(12) Patent Application Publication
(10) Pub. No.: US 2021/0010485 A1
(43) Pub. Date: Jan. 14, 2021

(54) ROTOR BLADE AND AXIAL FLOW ROTATING MACHINE WITH THE SAME

(71) Applicant: MITSUBISHI HEAVY INDUSTRIES, LTD., Tokyo (JP)

(72) Inventors: Tomohiro ISHIDA, Tokyo (JP); Toshifumi KANNO, Tokyo (JP); Hikaru KUROSAKI, Tokyo (JP); Eisaku ITO, Tokyo (JP)

(21) Appl. No.: 16/787,237

(22) Filed: Feb. 11, 2020

(30) Foreign Application Priority Data
Jul. 11, 2019 (JP) 2019-129337

(51) Int. Cl. F04D 29/38; F04D 29/52

(52) U.S. Cl. CPC F04D 29/38; F04D 29/522

(57) ABSTRACT

A rotor blade includes a shroud cover which is formed at a first end portion of a blade body. The shroud cover extends in a first direction separating away from a camber line of the blade body. The shroud cover includes a gas path surface exposed toward a second side in the blade height direction and a back surface exposed toward a first side in a blade height direction. The gas path surface includes a fillet surface which gradually extends toward the first side as it goes from each of a pressure surface and a suction surface of the blade body toward the first direction in a cross-section orthogonal to the camber line. The back surface is opposite to the gas path surface, and includes a recessed surface which extends so as to be recessed toward the second side along the fillet surface in the cross-section.

### BACKGROUND OF THE INVENTION

### Field of the Invention

The present invention relates to a rotor blade and an axial flow rotating machine with the same.

The present application claims priority to Japanese Patent Application No. 2019-129337 filed on Jul. 11, 2019, the content of which is incorporated herein by reference.

### Description of Related Art

A gas turbine which is a kind of axial flow rotating machine includes a rotor which rotates about an axis and a casing which covers the rotor. The rotor includes a rotor shaft and a plurality of rotor blades which are attached to the rotor shaft.

For example, the rotor blade of Patent Document below includes a blade body which forms an airfoil, a shroud, and a platform. The blade body extends in a radial direction with respect to an axis. Thus, a blade height direction of the blade body is the radial direction. The shroud is provided in an end on a radially outward side with respect to the axis of the blade body. The platform is provided in an end on a radially inward side with respect to the axis of the blade body. All of the shroud and the platform extend in a direction substantially perpendicular to the radial direction. The shroud includes a shroud main body (or a shroud cover) and two seal fins. The shroud main body includes a gas path surface which faces the radially inward side, and a back surface which is opposite to the gas path surface and which faces the radially outward side. Both seal fins protrude from the back surface of the shroud main body toward the radially outward side and extend in a circumferential direction with respect to the axis.

Both seal fins are arranged with a gap interposed therebetween in an axial direction in which the axis extends. The back surface of the shroud main body is provided with two recessed surfaces which are recessed toward the radially inward side. Two recessed surfaces are disposed between the two seal fins.

Patent Document 1: Japanese Unexamined Patent Application, First Publication No. 2008-038910

### SUMMARY OF THE INVENTION

As described above, the shroud is provided in an end on the radially outward side of the blade body. For this reason, an increase in weight of the shroud leads to an increase in centrifugal load applied to the blade body. Thus, it is preferable to decrease the centrifugal load applied to the blade body by decreasing the weight of the shroud. In the technique of Patent Document 1 above, since the back surface of the shroud main body is provided with the recessed surface, a decrease in weight of the shroud is realized to some extent.

Incidentally, in general, a fillet surface is provided in the gas path surface of the shroud main body. The fillet surface extends so as to be curved toward the radially outward side in a direction separating away from the airfoil in each of a pressure surface and a suction surface of the blade body in a cross-section orthogonal to a camber line of the blade body. Stress is generated in a base portion of the shroud main body with respect to the blade body. As a method of reducing the stress, a method of increasing the curvature radius of the fillet surface is known. However, when the curvature radius of the fillet surface is simply increased, the weight of the shroud main body (or the shroud cover) increases.

Here, an object of the present invention is to provide a technique capable of reducing the weight of a shroud cover while reducing stress generated in a base portion of the shroud cover with respect to a blade body.

A rotor blade of an aspect according to the present invention for achieving the above-described object includes: a blade body which has an airfoil shape and a shroud cover which is formed at a first end portion on a first side inside the blade body between the first and second sides of the blade body in a blade height direction. The shroud cover extends in a first direction intersecting the blade height direction and separating away from a camber line in the first end portion of the blade body. The shroud cover includes a gas path surface exposed to an outside toward the second side and a back surface exposed to an outside toward the first side. The gas path surface includes a fillet surface which gradually extends toward the first side as it separates from each of a pressure surface and a suction surface of the blade body in the first direction in a cross-section orthogonal to the camber line. The back surface is opposite to the gas path surface, and includes a recessed surface which extends so as to be recessed toward the second side along at least a part of a surface of the fillet surface in the cross-section.

Stress is generated in a base portion of the shroud cover with respect to the blade body. As a method of reducing this stress, a method of increasing the curvature radius of the fillet surface is known. The recessed surface of the aspect extends so as to be recessed toward the second side along the fillet surface in the gas path surface. For this reason, in this aspect, the cover thickness corresponding to a distance between the gas path surface and the back surface is not thickened even when the curvature radius of the fillet surface is increased. Thus, in this aspect, it is possible to reduce the weight of the shroud cover while reducing the stress generated in the base portion of the shroud cover with respect to the blade body.

Here, in the rotor blade of the aspect, the shroud cover may include a main body intermediate portion which corresponds to an intermediate portion of the fillet surface in a second direction intersecting the blade height direction and coming closer to the camber line of the blade body and the back surface in the main body intermediate portion may include at least one part of the recessed surface.

Further, in the rotor blade of any one of the aspects, the recessed surface may extend toward both sides with respect to the camber line in the cross-section. In this case, in the cross-section, a surface on a pressure side corresponding to a side of the pressure surface with respect to the camber line in the recessed surface faces the second side as it goes toward a suction side corresponding to a side of the suction surface with respect to the camber line. Further, in the cross-section, a surface on the suction side with respect to the camber line in the recessed surface faces the second side as it goes toward the pressure side.

In this aspect, since the recessed surface extends toward both sides with respect to the camber line, the weight of the shroud cover can be further reduced.

In the rotor blade of any one of the aspects, the shroud cover may include a cover main body and an outer edge portion connected to the cover main body. In this case, the outer edge portion is located in the first direction in relation to the cover main body in the cross-section and protrudes in the blade height direction with respect to the cover main body. Further, both the cover main body and the outer edge portion include the gas path surface and the back surface. The back surface of the cover main body includes the recessed surface.

In this aspect, it is possible to increase the rigidity of the outer edge of the shroud cover while suppressing an increase in weight of the shroud cover.

In the rotor blade of the aspect including the outer edge portion, the outer edge portion may protrude toward the first side in the blade height direction with respect to the cover main body.

In the rotor blade of any one of the aspects including the outer edge portion, a cover thickness which is a distance between the gas path surface and the back surface in the cross-section may be set such that the outer edge portion is thicker than a main body end which is an end of the cover main body and is connected to the outer edge portion.

In the rotor blade of the aspect including the main body end, the cover main body may include a main body intermediate portion which is located in the second direction intersecting the blade height direction and coming closer to the camber line of the blade body in relation to the main body end and corresponds to an intermediate portion of the fillet surface in the second direction. In this case, the cover thickness in the cross-section may be set such that the main body intermediate portion is thicker than the main body end.

In the rotor blade of the aspect including the main body intermediate portion, the cover main body may include a blade side portion which is located in the second direction in relation to the main body intermediate portion. In this case, the cover thickness in the cross-section may be set such that the main body intermediate portion is thicker than the blade side portion.

In the rotor blade of any one of the aspects including the outer edge portion and the main body end, the cover thickness in the cross-section may be set such that the outer edge portion in the shroud cover is the thickest.

In this aspect, it is possible to further reduce the weight of the shroud cover while increasing the rigidity of the outer edge of the shroud cover.

In the rotor blade of any one of the aspects including the outer edge portion and the main body end, the cover thickness in the cross-section may be set such that the main body end in the shroud cover is the thinnest.

In this aspect, the cover thickness of the main body end located at a region farther from the camber line in relation to the main body intermediate portion is the thinnest in the shroud cover. For this reason, in this aspect, it is possible to suppress an increase in moment applied to the shroud cover based on the camber line while increasing the rigidity of the outer edge of the shroud cover by the outer edge portion.

The rotor blade of any one of the aspects may further include: a seal fin which protrudes from the back surface of the shroud cover toward the first side and extends from a first portion of an outer edge of the back surface to a second portion of the outer edge of the back surface.

In the rotor blade of the aspect including the seal fin, the seal fin extends from the first portion of the outer edge of the back surface to the second portion of the outer edge of the back surface across the camber line. In this case, the height of the seal fin in the blade height direction may be set such that the height of an intermediate portion between the first portion and the second portion is higher than the height at a position of the first portion of the outer edge of the back surface and the height at a position of the second portion of the outer edge of the back surface.

The rotor blade of any one of the aspects may further include: a rib which protrudes from the back surface of the shroud cover toward the first side and extends from a part of the outer edge of the back surface toward another part of the outer edge of the back surface.

In this aspect, it is possible to increase the rigidity of the shroud cover while suppressing an increase in weight of a portion on the first side in relation to the blade body.

In the rotor blade of the aspect including the rib, the rib may extend from a part of an outer edge of the back surface to another part.

In this aspect, it is possible to increase the rigidity at a part and another part of the outer edge of the back surface in the shroud cover.

The rotor blade of the aspect including the seal fin may further include: a rib which protrudes from the back surface of the shroud cover toward the first side and extends from a part of the outer edge of the back surface to the seal fin.

In this aspect, it is possible to further increase the rigidity of the shroud cover while suppressing an increase in weight of a portion on the first side in relation to the blade body.

The rotor blade of the aspect including the seal fin may further include: a rib which protrudes from the back surface of the shroud cover toward the first side and extends from the seal fin in a direction intersecting the extending direction of the seal fin.

In this aspect, it is possible to increase the rigidity of the shroud cover while suppressing an increase in weight of a portion on the first side in relation to the blade body.

In the rotor blade of any one of the aspects, an area of the back surface may be 110% or more based on an area inside an outer edge of the back surface in an imaginary plane including the outer edge.

Further, in the rotor blade of any one of the aspects, in the cross-section, the back surface may include a first end and a second end which constitute the outer edge of the back surface and on the basis of a shroud cover cross-sectional area corresponding to an area of a region surrounded by the gas path surface and a line connecting the first and second ends in the cross-section, a recess area corresponding to an area of a region surrounded by the line and the back surface in the cross-section may be 20% or more thereof.

An axial flow rotating machine of an aspect according to the invention for achieving the above-described object includes: a plurality of rotor blades of any one of the aspects; a rotor shaft which rotates about an axis; and a casing. The plurality of rotor blades are arranged in a circumferential direction about the axis and are attached to the rotor shaft so that the blade height direction is a radial direction with respect to the axis. The casing covers an outer peripheral side of the rotor shaft and the plurality of rotor blades.

According to an aspect of the present invention, it is possible to reduce the weight of the shroud cover while reducing the stress generated in the base portion of the shroud cover with respect to the blade body.

### BRIEF DESCRIPTION OF THE DRAWINGS

FIG. 1 is a schematic cross-sectional view of a gas turbine according to an embodiment of the present invention.

FIG. 2 is a perspective view of a rotor blade according to a first embodiment of the present invention.

FIG. 3 is a diagram showing the rotor blade according to the first and second embodiments of the present invention when viewed from the outside in the radial direction.

FIG. 4 is a cross-sectional view taken along a line IV-IV of FIG. 3 showing the rotor blade according to the first embodiment of the present invention. p FIG. 5 is a cross-sectional view taken along a line V-V of FIG. 3 showing the rotor blade according to the first embodiment of the present invention.

FIG. 6 is a cross-sectional view taken along a line VI-VI of FIG. 3 showing the rotor blade according to the first embodiment of the present invention.

FIG. 7 is an explanatory diagram illustrating various areas for a shroud cover according to the first embodiment of the present invention.

FIG. 8 is a cross-sectional view taken along a line VIII-VIII of FIG. 3 showing the rotor blade according to the second embodiment of the present invention.

FIG. 9 is a cross-sectional view taken along a line IX-IX of FIG. 3 showing the rotor blade according to the second embodiment of the present invention.

FIG. 10 is a cross-sectional view taken along a line X-X of FIG. 3 showing the rotor blade according to the second embodiment of the present invention.

FIG. 11 is a diagram showing a rotor blade according to third and fourth embodiments of the present invention when viewed from the outside in the radial direction.

FIG. 12 is a cross-sectional view taken along a line XII-XII of FIG. 11 showing the rotor blade according to the third embodiment of the present invention.

FIG. 13 is a cross-sectional view taken along a line XIII-XIII of FIG. 11 showing the rotor blade according to the third embodiment of the present invention.

FIG. 14 is a cross-sectional view taken along a line XIV-XIV of FIG. 11 showing the rotor blade according to the fourth embodiment of the present invention.

FIG. 15 is a cross-sectional view taken along a line XV-XV of FIG. 11 showing the rotor blade according to the fourth embodiment of the present invention.

FIG. 16 is a diagram showing a rotor blade according to a modified example of the first and third embodiments of the present invention when viewed from the outside in the radial direction.

FIG. 17 is a diagram showing a rotor blade according to a modified example of the second and fourth embodiments of the present invention when viewed from the outside in the radial direction.

### DETAILED DESCRIPTION OF THE INVENTION

Hereinafter, various embodiments and modified examples of the present invention will be described with reference to the drawings.

“Embodiments of Axial Flow Rotating Machine”

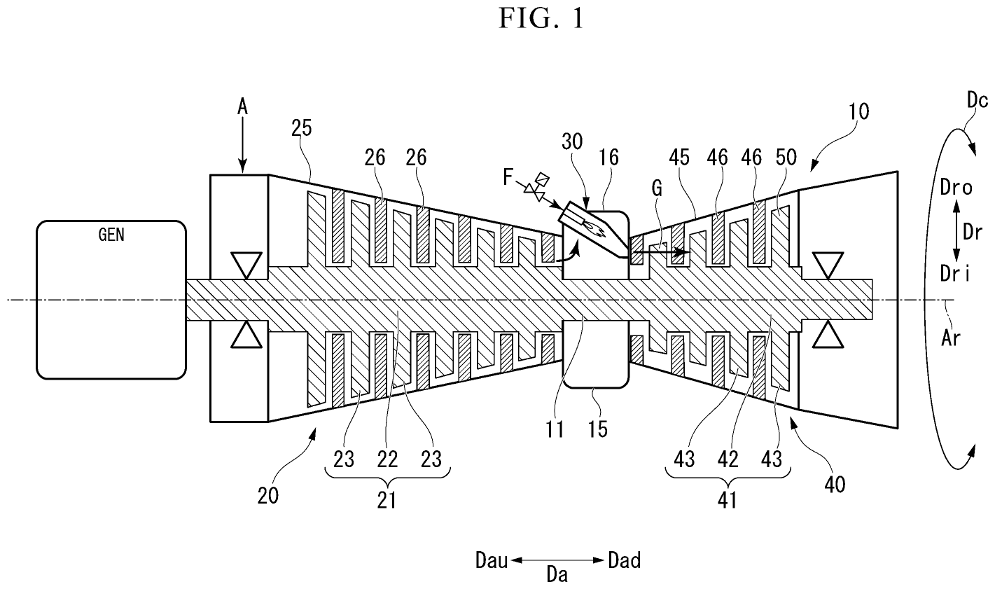

An embodiment of an axial flow rotating machine according to the present invention will be described with reference to FIG. 1.

An axial flow rotating machine of the embodiment is a gas turbine. A gas turbine 10 includes a compressor 20 which compresses air A, a combustor 30 which generates a combustion gas G by burning fuel F in air A compressed by the compressor 20, and a turbine 40 which is driven by the combustion gas G.

The compressor 20 includes a compressor rotor 21 which rotates about an axis Ar, a compressor casing 25 which covers the compressor rotor 21, and a plurality of stationary blade rows 26. The turbine 40 includes a turbine rotor 41 which rotates about an axis Ar, a turbine casing 45 which covers the turbine rotor 41, and a plurality of stationary blade rows 46. Additionally, hereinafter, an extending direction of the axis Ar is referred to as an axial direction Da, a circumferential direction about the axis Ar is simply referred to as a circumferential direction Dc, and a direction perpendicular to the axis Ar is referred to as a radial direction Dr. Further, one side in the axial direction Da is referred to as an axial upstream side Dau and the opposite side is referred to as an axial downstream side Dad. Further, a side closer to the axis Ar in the radial direction Dr is referred to as a radially inward side Dri and the opposite side thereof is referred to as a radially outward side Dro.

The compressor 20 is disposed on the axial upstream side Dau with respect to the turbine 40. The compressor rotor 21 and the turbine rotor 41 are located on the same axis Ar and are connected to each other so as to constitute a gas turbine rotor 11. For example, a rotor of a generator GEN is connected to the gas turbine rotor 11. The gas turbine 10 further includes an intermediate casing 14 which is disposed between the compressor casing 25 and the turbine casing 45. The combustor 30 is attached to the intermediate casing 14. The compressor casing 25, the intermediate casing 14, and the turbine casing 45 are connected to each other so as to constitute a gas turbine casing 15.

The compressor rotor 21 includes a rotor shaft 22 which extends in the axial direction Da about the axis Ar and a plurality of rotor blades rows 23 which are attached to the rotor shaft 22. The plurality of rotor blades rows 23 are arranged in the axial direction Da. Each rotor blade row 23 includes a plurality of rotor blades arranged in the circumferential direction Dc. Any one stationary blade row 26 of the plurality of stationary blade rows 26 is disposed on each axial downstream side Dad of the plurality of rotor blades rows 23. Each stationary blade row 26 is provided on the inside of the compressor casing 25. Each stationary blade row 26 includes a plurality of stationary blades arranged in the circumferential direction Dc.

The turbine rotor 41 includes a rotor shaft 42 which extends in the axial direction Da about the axis Ar and a plurality of rotor blades rows 43 which are attached to the rotor shaft 42. The plurality of rotor blades rows 43 are arranged in the axial direction Da. Each rotor blade row 43 includes a plurality of rotor blades 50 arranged in the circumferential direction Dc. Any one stationary blade row 46 of the plurality of stationary blade rows 46 is disposed on each axial upstream side Dau of the plurality of rotor blades rows 43. Each stationary blade row 46 is provided inside the turbine casing 45. Each stationary blade row 46 includes a plurality of stationary blades arranged in the circumferential direction Dc.

The compressor 20 sucks the air A and compresses the air. Compressed air, that is, compression air flows into the combustor 30 through the intermediate casing 14. The fuel F is supplied from the outside into the combustor 30. The combustor 30 generates the combustion gas G by burning the fuel F in the compression air. The combustion gas G flows into the turbine casing 45 and rotates the turbine rotor 41. The generator GEN generates electric power by the rotation of the turbine rotor 41.

Hereinafter, various embodiments of the above-described rotor blade will be described.

“First Embodiment of Rotor Blade”

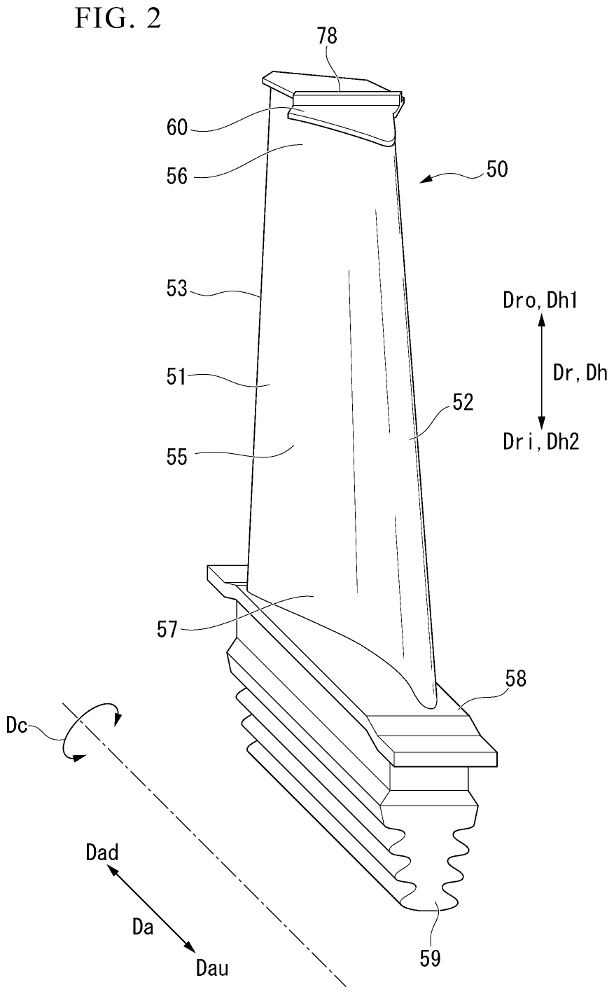

Referring to FIGS. 2 to 7, a rotor blade according to a first embodiment of the present invention will be described.

The rotor blade 50 of the embodiment includes, as shown in FIG. 2, a blade body 51 which has an airfoil shape, a platform 58, a blade base 59, a shroud cover 60, and a seal fin 78. A blade height direction Dh of the blade body 51 is the radial direction Dr in a state in which the rotor blade 50 is attached to the rotor shaft 42 (see FIG. 1). The shroud cover 60 is provided at a first end portion 56 of the blade body 51. The platform 58 is provided at a second end portion 57 of the blade body 51. The first end portion 56 of the blade body 51 is an end portion on a first side Dh1 between the first side Dh1 and the second side Dh2 in the blade height direction Dh. The second end portion 57 of the blade body 51 is an end portion on the second side Dh2 in the blade height direction Dh. The first side Dh1 in the blade height direction Dh is the radially outward side Dro in a state in which the rotor blade 50 is attached to the rotor shaft 42.

Further, the second side Dh2 in the blade height direction Dh is the radially inward side Dri in a state in which the rotor blade 50 is attached to the rotor shaft 42. Here, hereinafter, the blade height direction Dh is referred to as the radial direction Dr, the first side Dh1 in the blade height direction Dh is referred to as the radially outward side Dro, and the second side Dh2 in the blade height direction Dh is referred to as the radially inward side Dri.

The shroud cover 60 and the platform 58 extend in a direction having a direction component perpendicular to the radial direction Dr. The blade base 59 is provided on the radially inward side Dri of the platform 58. The blade base 59 is a structure for attaching the rotor blade 50 to the rotor shaft 42.

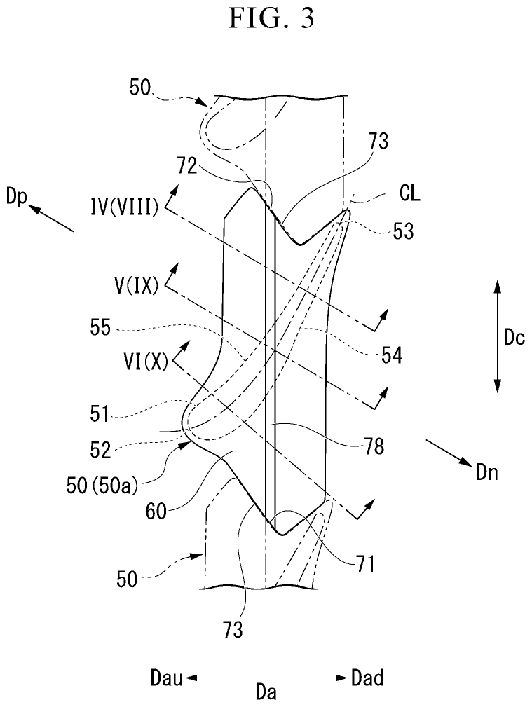

The blade body 51 includes, as shown in FIGS. 2 and 3, a leading edge 52, a trailing edge 53, a suction surface (dorsal surface) 54 which is a raised surface, and a pressure surface (ventral surface) 55 which is a recessed surface. The leading edge 52 and the trailing edge 53 are present at a connection portion between the suction surface 54 and the pressure surface 55. Both the leading edge 52 and the trailing edge 53 extend in the radial direction Dr which is the blade height direction Dh. The leading edge 52 is located on the axial upstream side Dau with respect to the trailing edge 53 in a state in which the rotor blade 50 is attached to the rotor shaft 42.

The shroud cover 60 includes a contact surface 73 on both sides in the circumferential direction Dc. The contact surface 73 in the shroud cover 60 faces and contacts a contact surface 73 of the shroud cover 60 of another rotor blade 50 adjacent to the rotor blade 50 having the shroud cover 60 in the circumferential direction Dc. The seal fin 78 extends in the circumferential direction Dc from a first portion 71 which is a part of the outer edge existing at one side of the shroud cover 60 in the circumferential direction Dc to a second portion 72 which is a part of the outer edge existing at the other side of the shroud cover 60 in the circumferential direction Dc.

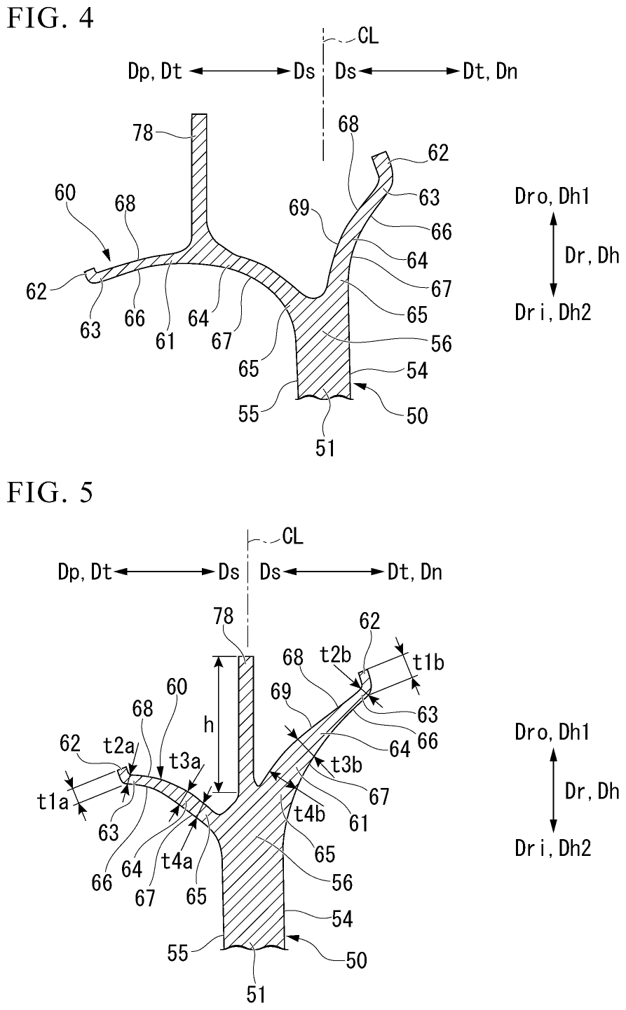

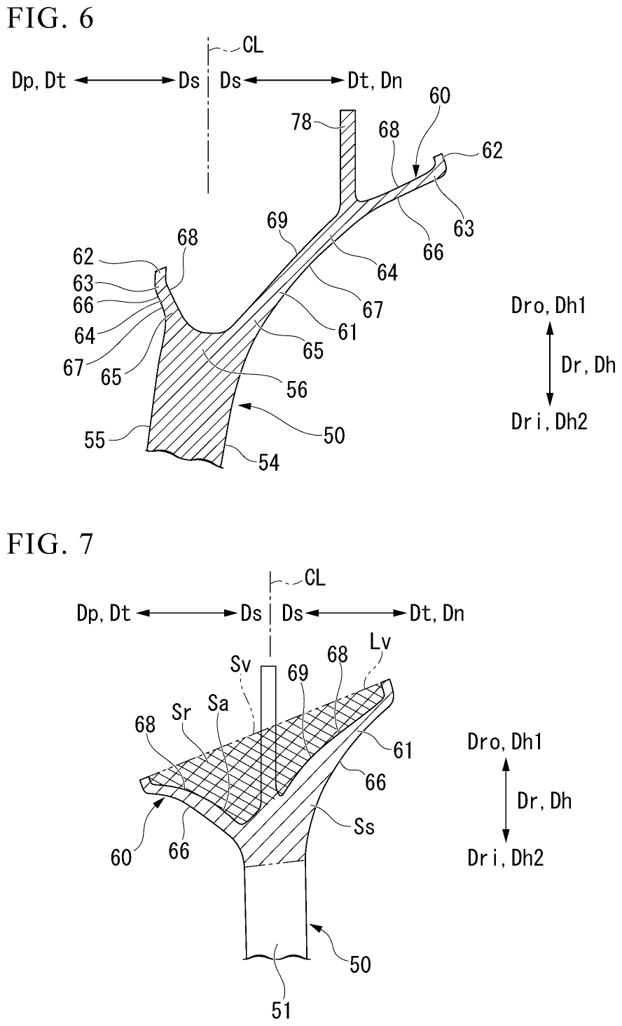

In a cross-section orthogonal to a camber line CL of the blade body 51 as shown in FIGS. 4 to 6, the shroud cover 60 extends in both directions Dt of which each separates away from the blade body 51. Additionally, FIG. 4 is a cross-sectional view taken along a line IV-IV of FIG. 3, FIG. 5 is a cross-sectional view taken along a line V-V of FIG. 3, and FIG. 6 is a cross-sectional view taken along a line VI-VI of FIG. 3. All three cross-sectional views are cross-sectional views in a cross-section orthogonal to the camber line CL of the blade body 51. Further, in these cross-sectional views, a member existing at the inside of the cross-section is not depicted. Each of the directions Dt separates away from the blade body 51 and is orthogonal to the radial direction Dr (the blade height direction Dh). Also, each of directions Ds comes close to the blade body 51 and is orthogonal to the radial direction Dr (the blade height direction Dh). Thus, the direction Ds is opposite to the direction Dt. One direction Dt on the suction side Dn in which the suction surface 54 exists with respect to the camber line CL is opposite to the other direction Dt on the pressure side Dp in which the pressure surface 55 exists with respect to the camber line CL. Also, one direction Ds on the suction side Dn with respect to the camber line CL is opposite to the other direction Ds on the pressure side Dp with respect to the camber line CL.

The shroud cover 60 includes a cover main body 61 and an outer edge portion 62 which is connected to the cover main body 61. The outer edge portion 62 is located in the direction Dt with respect to the cover main body 61 in a cross-section orthogonal to the camber line CL. In other words, the cover main body 61 is located in the direction Ds with respect to the outer edge portion 62 in a cross-section orthogonal to the camber line CL. The outer edge portion 62 protrudes in the radial direction Dr (the blade height direction Dh) with respect to the cover main body 61. In the embodiment, the outer edge portion 62 protrudes toward the radially outward side Dro with respect to the cover main body 61 (the first side Dh1 in the blade height direction Dh). The above-described contact surface 73 is formed in a part of the outer edge portion 62.

Both the cover main body 61 and the outer edge portion 62 include a gas path surface 66 and a back surface 68 which is opposite to the gas path surface 66. The gas path surface 66 is exposed to the outside of the rotor blade 50 toward the radially inward side Dri (the second side Dh2 in the blade height direction Dh). The back surface 68 is exposed to the outside of the rotor blade 50 toward the radially outward side Dro (the first side Dh1 in the blade height direction Dh).

The gas path surface 66 includes a fillet surface 67 which gradually extends to the radially outward side Dro (the first side Dh1 in the blade height direction Dh) as it separates from the blade body 51 in the direction Dt in a cross-section orthogonal to the camber line CL. The fillet surface 67 is curved. The back surface 68 includes a recessed surface 69 which extends so as to be recessed to the radially inward side Dri (the second side Dh2 in the blade height direction Dh) as it comes close to the blade body 51 in the direction Ds in a cross-section orthogonal to the camber line CL. In other words, the recessed surface 69 extends so as to be recessed to the radially inward side Dri along the fillet surface 67 in the gas path surface 66. The recessed surface 69 extends to both sides with respect to the camber line CL. For this reason, in a cross-section orthogonal to the camber line CL, a part of the recessed surface 69 is located on the suction side Dn with respect to the camber line CL and the rest of the recessed surface 69 is located on the pressure side Dp with respect to the camber line CL. A part of the recessed surface 69 located on the suction side Dn is inclined toward the pressure side Dp as it goes toward the radially inward side Dri and the rest of the recessed portion located on the pressure side Dp is inclined to the suction side Dn as it goes toward the radially inward side Dri. Thus, a part of the recessed surface 69 located on the suction side Dn and the rest of the recessed portion located on the pressure side Dp are inclined in the opposite direction.

The cover main body 61 includes a main body end 63, a main body intermediate portion 64, and a blade side portion 65. The main body intermediate portion 64 is a portion corresponding to an intermediate portion of the fillet surface 67 in the direction Ds of the cover main body 61 in a cross-section orthogonal to the camber line CL. The blade side portion 65 is a portion which is located in the direction Ds with respect to the main body intermediate portion 64 of the cover main body 61 in a cross-section orthogonal to the camber line CL. The main body end 63 is a portion which is the end of the cover main body 61 and is connected to the outer edge portion 62. The recessed surface 69 is formed throughout the main body end 63, the main body intermediate portion 64, and the blade side portion 65.

Here, a distance between the gas path surface 66 and the back surface 68 is set to a cover thickness. In the cross-sections shown in FIGS. 4 to 6, the cover thicknesses t1a and t1b of the outer edge portion 62 are thicker than the cover thicknesses t2a and t2b of the main body end 63. The cover thicknesses t3a and t3b of the main body intermediate portion 64 are also thicker than the cover thicknesses t2a and t2b of the main body end 63. Further, the cover thicknesses t4a and t4b of the blade side portion 65 are also thicker than the cover thicknesses t2a and t2b of the main body end 63. That is, the cover thicknesses t2a and t2b of the main body end 63 are the thinnest in any cross-section.

The seal fin 78 protrudes from the back surface 68 of the shroud cover 60 toward the radially outward side Dro (the first side Dh1 in the blade height direction Dh) and extends in the circumferential direction Dc. A distance from the axis Ar to the front end which is the end on the radially outward side Dro of the seal fin 78 is uniform regardless of the position in the circumferential direction Dc. However, the fin height h (see FIG. 5) at the position of the intermediate portion between the first portion 71 and the second portion 72 is higher than the fin height of the first portion 71 (see FIG. 3) of the outer edge existing at one side of the shroud cover 60 in the circumferential direction Dc and the fin height of the second portion 72 (see FIG. 3) of the outer edge existing at the other side of the shroud cover 60 in the circumferential direction Dc. This is because the back surface 68 includes the recessed surface 69. Additionally, the fin height h is a distance from the back surface 68 to the front end of the seal fin 78.

As shown in FIG. 7, an area Sa of the back surface 68 is wider than an area Sv inside the outer edge in the imaginary plane including the outer edge of the back surface 68. Specifically, the area Sa of the back surface 68 is 110% or more and preferably 120% or more with respect to the area Sv inside the outer edge in the imaginary plane.

Further, as shown in FIG. 7, on the basis of a shroud cover cross-sectional area Ss corresponding to an area of a region surrounded by the gas path surface 66 and a line Lv connecting the first and second ends constituting the outer edge of the back surface 68 in a cross-section orthogonal to the camber line CL, a recess cross-sectional area Sr which is an area of a region surrounded by the line Lv and the back surface 68 in this cross-section is 20% or more and preferably 30% or more. Additionally, the above-described imaginary plane is a plane including the line Lv.

As described above, in the embodiment, since the back surface 68 includes the recessed surface 69 which is recessed in the radially inward side Dr, the weight of the shroud cover 60 can be reduced.

Incidentally, stress is generated in the base portion of the shroud cover 60 with respect to the blade body 51. As a method of reducing this stress, a method of increasing the curvature radius of the fillet surface 67 is known. The recessed surface 69 of the embodiment extends so as to be recessed to the radially inward side Dri along the fillet surface 67 in the gas path surface 66. For this reason, in the embodiment, even when the curvature radius of the fillet surface 67 is large, a cover thickness which is a distance between the gas path surface 66 and the back surface 68 is not thick. Thus, in the embodiment, it is possible to reduce the weight of the shroud cover 60 while reducing the stress generated in the base portion of the shroud cover 60 with respect to the blade body 51. Further, in the embodiment, since the recessed surface 69 extends toward both sides with respect to the camber line CL, it is possible to further reduce the weight of the shroud cover 60.

In the embodiment, since the outer edge portion 62 which protrudes in the radial direction Dr with respect to the cover main body 61 is provided, it is possible to increase the rigidity of the outer edge of the shroud cover 60 while suppressing an increase in weight of the shroud cover 60. In the embodiment, the cover thicknesses t2a and t2b of the main body end 63 located at a region farther from the camber line CL with respect to the main body intermediate portion 64 are the thinnest in the shroud cover 60. For this reason, in the embodiment, it is possible to suppress an increase in moment applied to the fillet with respect to the camber line CL while increasing the rigidity of the outer edge of the shroud cover 60 by the outer edge portion 62.

Additionally, in the embodiment, the size relationship of the cover thicknesses t1a and t1b of the outer edge portion 62, the cover thicknesses t3a and t3b of the main body intermediate portion 64, and the cover thicknesses t4a and t4b of the blade side portion 65 does not matter. However, when the cover thicknesses t1a and t1b of the outer edge portion 62 are the thickest, it is possible to further reduce the weight of the shroud cover 60 while increasing the rigidity of the outer edge of the shroud cover 60.

“Second Embodiment of Rotor Blade”

Referring to FIGS. 3 and FIGS. 8 to 10, a rotor blade according to a second embodiment of the present invention will be described.

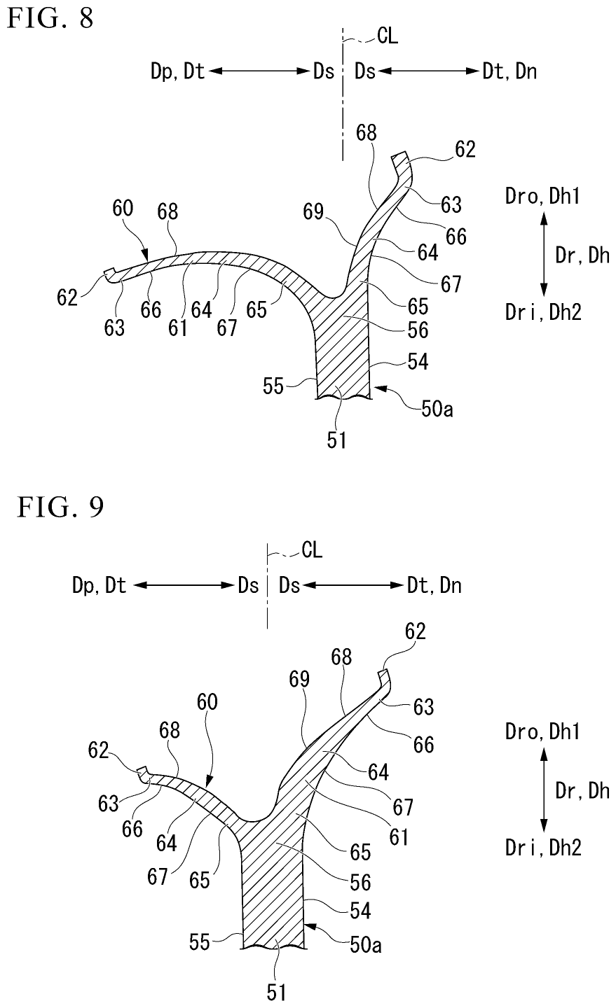

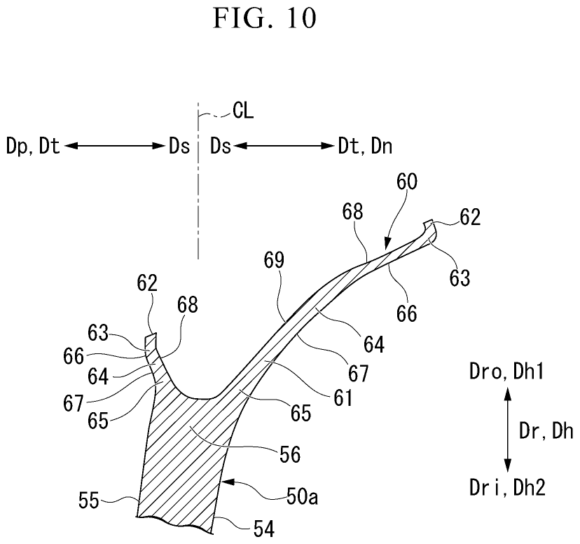

As shown in FIGS. 8 to 10, the configuration of the rotor blade 50a of the embodiment is a configuration in which the seal fin 78 is omitted from the configuration of the rotor blade 50 of the first embodiment and the other configuration is the same as the configuration of the rotor blade 50 of the first embodiment. Additionally, FIG. 8 is a cross-sectional view taken along a line VIII-VIII of FIG. 3, FIG. 9 is a cross-sectional view taken along a line IX-IX of FIG. 3, and FIG. 10 is a cross-sectional view taken along a line X-X of FIG. 3. Further, in the description of the rotor blade 50a of the embodiment, the seal fin 78 is depicted for descriptive purposes in FIG. 3 showing the rotor blade 50 of the first embodiment. However, in views in which the rotor blade 50a of the embodiment is viewed from the radially outward side Dro, the seal fin 78 is not depicted in a rigorous manner.

As described above, the configuration of the rotor blade 50a of the embodiment is a configuration in which the seal fin 78 is omitted from the configuration of the rotor blade 50 of the first embodiment and the other configuration is the same as the configuration of the rotor blade 50 of the first embodiment. For this reason, also in the embodiment, the same effect as that of the first embodiment can be obtained. That is, also in the embodiment, it is possible to reduce the weight of the shroud cover 60 while reducing the stress generated in the base portion of the shroud cover 60 with respect to the blade body 51.

“Third Embodiment of Rotor Blade”

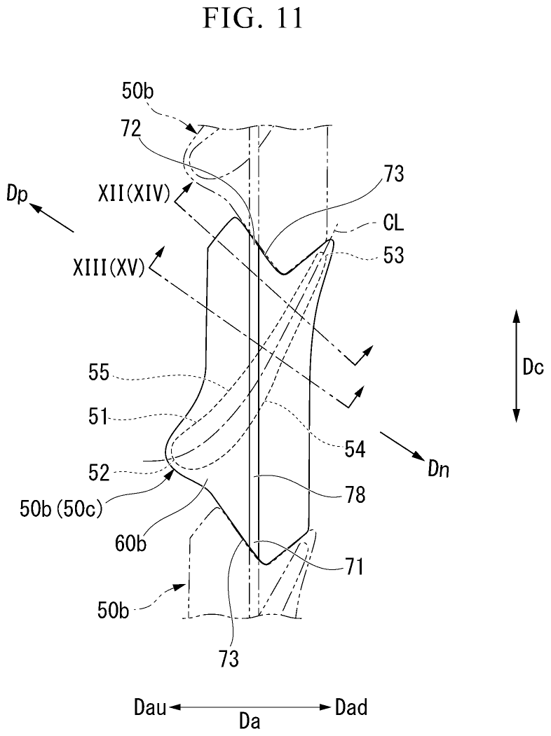

Referring to FIGS. 11 to 13, a rotor blade of the embodiment will be described.

A rotor blade 50b of the embodiment is a rotor blade obtained by changing the cover thickness of the rotor blade 50 of the first embodiment and the other configuration of the rotor blade 50b of the embodiment is the same as the configuration of the rotor blade 50 of the first embodiment.

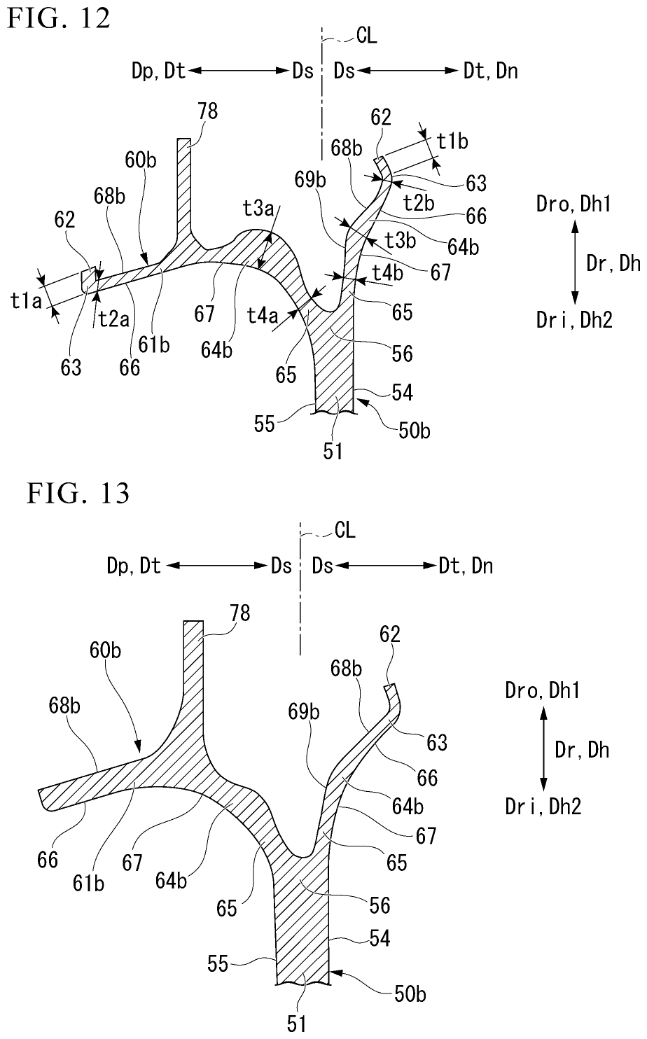

For this reason, the shroud cover 60b of the embodiment also includes, as shown in FIGS. 12 and 13, the outer edge portion 62 and a cover main body 61b similarly to the shroud cover 60 of the first embodiment. Both the cover main body 61b and the outer edge portion 62 include the gas path surface 66 and an back surface 68b. The gas path surface 66 of the embodiment includes the fillet surface 67 similarly to the gas path surface 66 of the first embodiment. The back surface 68b of the embodiment includes a recessed surface 69b similarly to the back surface 68 of the first embodiment. The recessed surface 69b is recessed toward the radially inward side Dri along the fillet surface 67 in the gas path surface 66. Further, the cover main body 61b of the embodiment also includes the main body end 63, a main body intermediate portion 64b, and the blade side portion 65 similarly to the cover main body 61 of the first embodiment. Additionally, FIG. 12 is a cross-sectional view taken along a line XII-XII of FIG. 11 and FIG. 13 is a cross-sectional view taken along a line XIII-XIII of FIG. 11. Both these cross-sectional views are cross-sectional views for a cross-section orthogonal to the camber line CL of the blade body 51.

In a cross-section shown in FIG. 12, the cover thicknesses t1a and t1b of the outer edge portion 62 are thicker than the cover thicknesses t2a and t2b of the main body end 63. The cover thicknesses t3a and t3b of the main body intermediate portion 64b are also thicker than the cover thicknesses t2a and t2b of the main body end 63. Further, the cover thicknesses t4a and t4b of the blade side portion 65 are also thicker than the cover thicknesses t2a and t2b of the main body end 63. That is, the cover thicknesses t2a and t2b of the main body end 63 are the thinnest in this cross-section. In the embodiment, the cover thicknesses t3a and t3b of the main body intermediate portion 64b are thicker than the cover thicknesses t4a and t4b of the blade side portion 65. For this reason, in the embodiment, the cover thickness is gradually thickened from the main body end 63 to the main body intermediate portion 64b and the cover thickness is gradually thinned from the main body intermediate portion 64b to the blade side portion 65.

The recessed surface 69b of the embodiment is also a surface which is recessed toward the radially inward side Dri along the fillet surface 67 in the gas path surface 66 similarly to the recessed surface 69 of the first embodiment. For this reason, also in the embodiment, it is possible to reduce the weight of the shroud cover 60b while reducing the stress generated in the base portion of the shroud cover 60b with respect to the blade body 51 similarly to the first embodiment. Further, also in the embodiment, since the recessed surface 69b extends to both sides with respect to the camber line CL, it is possible to further reduce the weight of the shroud cover 60b.

Also in the embodiment, since the outer edge portion 62 which protrudes in the radial direction Dr with respect to the cover main body 61b is provided, it is possible to increase the rigidity of the outer edge of the shroud cover 60b while suppressing an increase in weight of the shroud cover 60b.

Further, also in the embodiment, the cover thicknesses t2a and t2b of the main body end 63 located in the direction Dt with respect to the main body intermediate portion 64b in the shroud cover 60b are the thinnest. For this reason, also in the embodiment, it is possible to suppress an increase in moment applied to the shroud cover 60b with respect to the camber line CL while increasing the rigidity of the outer edge of the shroud cover 60b by the outer edge portion 62.

The load applied to the main body intermediate portion 64b in the cover main body 61b is larger than the load applied to the main body end 63 or the blade side portion 65. In the embodiment, since the cover thickness of the main body intermediate portion 64b is thicker than that of the blade side portion 65, it is possible to reduce the stress generated in the main body intermediate portion 64b.

Additionally, in the embodiment, the size relationship of the cover thicknesses t1a and t1b of the outer edge portion 62 and the cover thicknesses t3a and t3b of the main body intermediate portion 64 does not matter. However, the cover thicknesses t1a and t1b of the outer edge portion 62 may be thicker than the cover thicknesses t3a and t3b of the main body intermediate portion 64b and may be the thickest in the shroud cover 60b. In this case, it is possible to further reduce the weight of the shroud cover 60b while increasing the rigidity of the outer edge of the shroud cover 60b. Meanwhile, the cover thicknesses t3a and t3b of the main body intermediate portion 64b may be thicker than the cover thicknesses t1a and t1b of the outer edge portion 62 and may be the thickest in the shroud cover 60b. In this case, it is possible to reduce the stress generated in the main body intermediate portion 64b while suppressing an increase in weight of the shroud cover 60b.

Further, in the embodiment, the cover thickness t3a of the main body intermediate portion 64b is thicker than the cover thickness t4a of the blade side portion 65 on the pressure side Dp with respect to the camber line CL and the cover thickness t3b of the main body intermediate portion 64b is thicker than the cover thickness t4b of the blade side portion 65 also on the suction side Dn with respect to the camber line CL. However, the cover thickness of the main body intermediate portion 64b may be thicker than the cover thickness of the blade side portion 65 only on one side of the pressure side Dp and the suction side Dn with respect to the camber line CL.

“Fourth Embodiment of Rotor Blade”

Referring to FIGS. 11, 14, and 15, a rotor blade 50 according to a fourth embodiment of the present invention will be described.

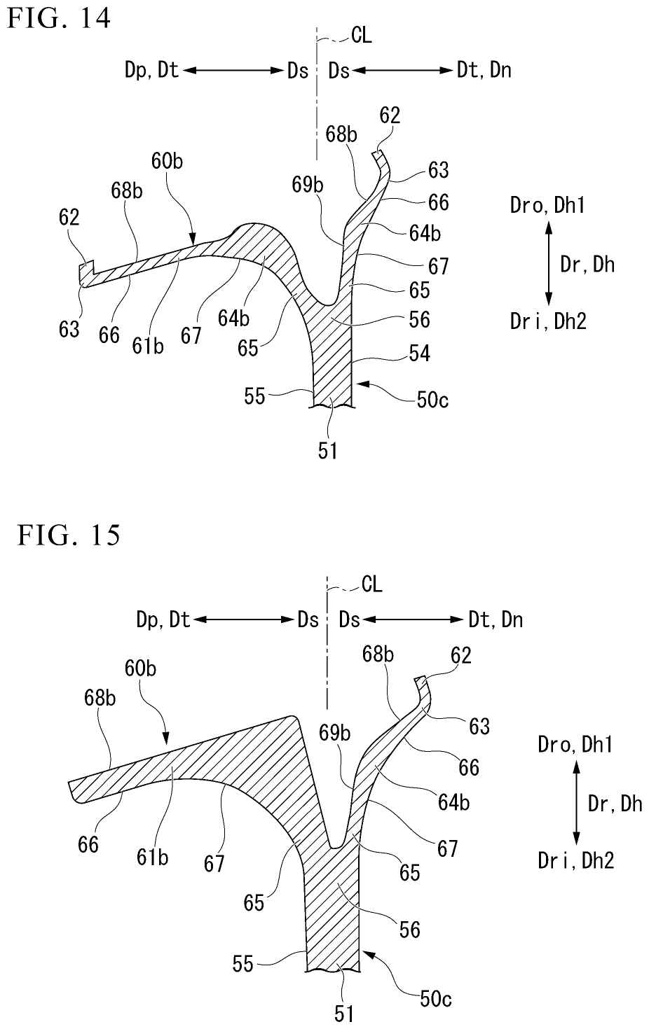

As shown in FIGS. 14 and 15, the configuration of the rotor blade 50c of the embodiment is a configuration in which the seal fin 78 is omitted from the configuration of the rotor blade 50b of the third embodiment and the other configuration is basically the same as the configuration of the rotor blade 50b of the third embodiment. Additionally, FIG. 14 is a cross-sectional view taken along a line XIV-XIV of FIG. 11 and FIG. 15 is a cross-sectional view taken along a line XV-XV of FIG. 11. Further, in the description of the rotor blade 50c of the embodiment, the seal fin 78 is depicted for descriptive purposes in FIG. 11 showing the rotor blade 50b of the third embodiment. However, in views in which the rotor blade 50c of the embodiment is viewed from the radially outward side Dro, the seal fin 78 is not depicted in a rigorous manner.

As described above, the configuration of the rotor blade 50c of the embodiment is a configuration in which the seal fin 78 is omitted from the configuration of the rotor blade 50b of the third embodiment and the other configuration is basically the same as the configuration of the rotor blade 50b of the third embodiment. For this reason, also in the embodiment, the same effect as that of the third embodiment can be obtained. That is, also in the embodiment, it is possible to reduce the weight of the shroud cover 60b while reducing the stress generated in the base portion of the shroud cover 60b with respect to the blade body 51. Further, also in the embodiment, since the cover thickness of the main body intermediate portion 64b is thicker than that of the blade side portion 65 similarly to the rotor blade 50b of the third embodiment, it is possible to reduce the stress generated in the main body intermediate portion 64b.

Additionally, in the shroud cover 60b of the embodiment, the outer edge portion 62 is not formed on the pressure side Dp with respect to the camber line CL as shown in

FIG. 15 in a cross-section taken along a line XV-XV of FIG. 11. Further, the recessed surface 69b is not formed in the direction Dt in relation to a position corresponding to the intermediate portion of the fillet surface 67 in the direction Ds on the pressure side Dp and the recessed surface 69b is formed from that position in the direction Ds.

“Other Modified Examples”

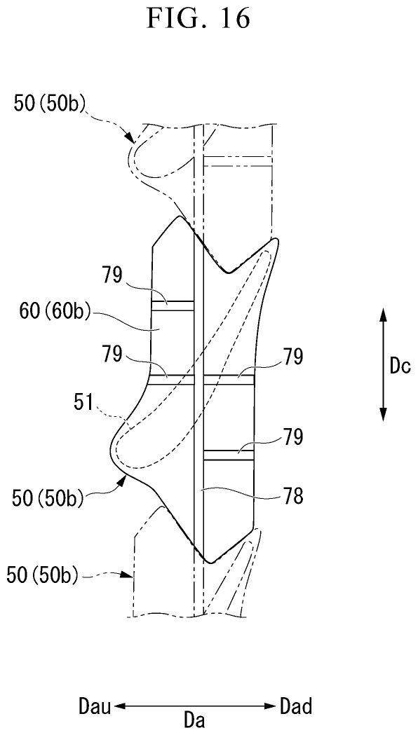

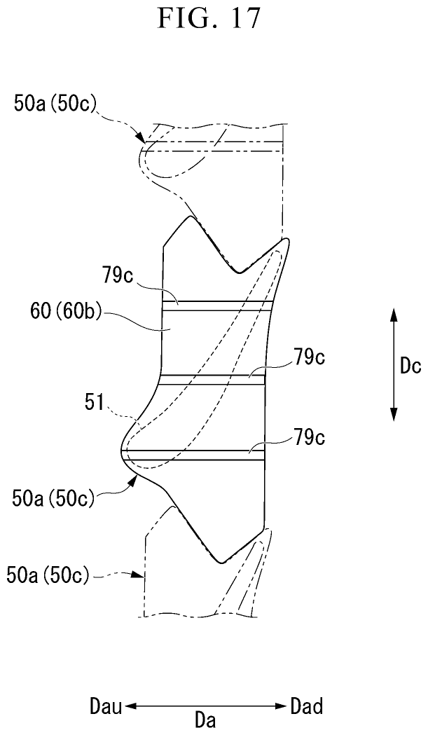

In the rotor blades of the above-described embodiments, a rib which protrudes from the back surface of the shroud cover to the radially outward side Dro may be added. For example, as shown in FIG. 16, a plurality of ribs 79 which extend from a part of the outer edges of the shroud covers 60 and 60b to the seal fin 78 in the axial direction Da may be added to the rotor blades 50 and 50b of the first embodiment and the third embodiment including the seal fin 78. Additionally, the rib 79 shown in FIG. 16 may not extend from a part of the outer edges of the shroud covers 60 and 60b. For example, the rib 79 may extend from the seal fin 78 in a direction intersecting the extending direction of the seal fin 78 and the rib 79 may not reach a part of the outer edges of the shroud covers 60 and 60b. Further, as shown in FIG. 17, a plurality of ribs 79c which extend from a part of the outer edges of the shroud covers 60 and 60b to the other part of another edges of the shroud covers 60 and 60b in the axial direction Da may be added to the rotor blades 50a and 50c of the second embodiment and the fourth embodiment not including the seal fin 78.

In this way, since the ribs 79 and 79c are provided, it is possible to increase the rigidity of the shroud cover while suppressing an increase in weight of a portion on the radially outward side Dro in relation to the blade body 51. Additionally, the above-described ribs 79 and 79c basically do not protrude to the radially outward side Dro with respect to the imaginary plane including the outer edge of the back surface 68 described using FIG. 7.

The rotor blade of the configuration described in the embodiments and the modified examples above is the rotor blade of the gas turbine. However, the rotor blade of the configuration described in the embodiments and the modified examples above is not limited to the rotor blade of the gas turbine and may be a rotor blade of another axial flow rotating machine, for example, a steam turbine.

### EXPLANATION OF REFERENCES

10 Gas turbine

11 Gas turbine rotor

14 Intermediate casing

15 Gas turbine casing

20 Compressor

21 Compressor rotor

22 Rotor shaft

23 Rotor blade row

25 Compressor casing

26 Stationary blade row

30 Combustor

40 Turbine

41 Turbine rotor

42 Rotor shaft

43 Rotor blade row

45 Turbine casing

46 Stationary blade row

50, 50a, 50b, 50c Rotor blade

51 Blade body

52 Leading edge

53 Trailing edge

54 Suction surface

55 Pressure surface

56 First end portion

57 Second end portion

58 Platform

59 Blade base

60, 60b Shroud cover

61, 61b Cover main body

62 Outer edge portion

63 Main body end

64, 64b Main body intermediate portion

65 Blade side portion

66 Gas path surface

67 Fillet surface

68, 68b Back surface

69, 69b Recessed surface

71 First portion

72 Second portion

73 Contact surface

78 Seal fin

79, 79c Rib

A Air

F Fuel

G Combustion gas

CL Camber line

Sa Area of back surface

Sv Area inside outer edge in imaginary plane

Sr Recess cross-sectional area

Ss Shroud cover cross-sectional area

Ar Axis

Da Axial direction

Dau Axial upstream side

Dad Axial downstream side

Dc Circumferential direction

Dr Radial direction

Dri Radial inside

Dro Radial outside

Dh Blade height direction

Dh1 First side in blade height direction

Dh2 Second side in blade height direction

Dn Suction side

Dp Pressure side

What is claimed is:

1. A rotor blade comprising:
a blade body which has an airfoil shape; and
a shroud cover which is formed at a first end portion on a first side inside the blade body between the first and second sides of the blade body in a blade height direction, wherein
the shroud cover extends in a first direction intersecting the blade height direction and separating away from a camber line in the first end portion of the blade body,
the shroud cover comprises a gas path surface exposed to an outside toward the second side, and a back surface which is opposite to the gas path surface and which is exposed to an outside toward the first side,
the gas path surface comprises a fillet surface which gradually extends toward the first side as it separates from each of a pressure surface and a suction surface of the blade body in the first direction in a cross-section orthogonal to the camber line, and
the back surface comprises a recessed surface which extends so as to be recessed toward the second side along at least a part of a surface of the fillet surface in the cross-section.

2. The rotor blade according to claim 1, wherein
the shroud cover comprises a main body intermediate portion which corresponds to an intermediate portion of the fillet surface in a second direction intersecting the blade height direction and coming closer to the camber line of the blade body, and
the back surface in the main body intermediate portion comprises at least a part of the recessed surface.

3. The rotor blade according to claim 1, wherein
the recessed surface extends toward both sides with respect to the camber line in the cross-section, and
in the cross-section, a surface on a pressure side corresponding to a side of the pressure surface with respect to the camber line in the recessed surface faces the second side as it goes toward a suction side corresponding to a side of the suction surface with respect to the camber line and a surface on the suction side with respect to the camber line in the recessed surface faces the second side as it goes toward the pressure side.

4. The rotor blade according to claim 1, wherein
the shroud cover comprises a cover main body and an outer edge portion connected to the cover main body,
the outer edge portion is located in the first direction in relation to the cover main body in the cross-section and protrudes in the blade height direction with respect to the cover main body,
both the cover main body and the outer edge portion comprise the gas path surface and the back surface, and
the back surface of the cover main body comprises the recessed surface.

5. The rotor blade according to claim 4, wherein
the outer edge portion protrudes toward the first side in the blade height direction with respect to the cover main body.

6. The rotor blade according to claim 4, wherein
a cover thickness which is a distance between the gas path surface and the back surface in the cross-section is set such that the outer edge portion is thicker than a main body end which is an end of the cover main body and is connected to the outer edge portion.

7. The rotor blade according to claim 6, wherein
the cover main body comprises a main body intermediate portion which is located in the second direction intersecting the blade height direction and coming closer to the camber line of the blade body in relation to the main body end and corresponds to an intermediate portion of the fillet surface in the second direction, and
the cover thickness in the cross-section is set such that the main body intermediate portion is thicker than the main body end.

8. The rotor blade according to claim 7, wherein
the cover main body comprises a blade side portion which is located in the second direction in relation to the main body intermediate portion, and
the cover thickness in the cross-section is set such that the main body intermediate portion is thicker than the blade side portion.

9. The rotor blade according to claim 6, wherein
the cover thickness in the cross-section is set such that the outer edge portion in the shroud cover is the thickest.

10. The rotor blade according to claim 6, wherein
the cover thickness in the cross-section is set such that the main body end in the shroud cover is the thinnest.

11. The rotor blade according to claim 1, further comprising:
a seal fin which protrudes from the back surface of the shroud cover toward the first side and extends from a first portion of an outer edge of the back surface to a second portion of the outer edge of the back surface.

12. The rotor blade according to claim 11, wherein
the seal fin extends from the first portion of the outer edge of the back surface to the second portion of the outer edge of the back surface across the camber line, and
the height of the seal fin in the blade height direction is set such that the height of an intermediate portion between the first portion and the second portion is higher than the height at a position of the first portion of the outer edge of the back surface and the height at a position of the second portion of the outer edge of the back surface.

13. The rotor blade according to claim 1, further comprising:
a rib which protrudes from the back surface of the shroud cover toward the first side and extends from a part of the outer edge of the back surface toward the other part of the outer edge of the back surface.

14. The rotor blade according to claim 13, wherein the rib extends from a part of an outer edge of the back surface to another part.

15. The rotor blade according to claim 11, further comprising:
a rib which protrudes from the back surface of the shroud cover toward the first side and extends from a part of the outer edge of the back surface to the seal fin.

16. The rotor blade according to claim 11, further comprising:
a rib which protrudes from the back surface of the shroud cover toward the first side and extends from the seal fin in a direction intersecting the extending direction of the seal fin.

17. The rotor blade according to claim 1, wherein
an area of the back surface is 110% or more based on an area inside an outer edge of the back surface in an imaginary plane including the outer edge.

18. The rotor blade according to claim 1, wherein
in the cross-section, the back surface comprises a first end and a second end which constitute the outer edge of the back surface, and
on the basis of a shroud cover cross-sectional area corresponding to an area of a region surrounded by the gas path surface and a line connecting the first and second ends in the cross-section, a recess area corresponding to an area of a region surrounded by the line and the back surface in the cross-section is 20% or more.

19. An axial flow rotating machine comprising:
a plurality of the rotor blades according to claim 1;
a rotor shaft which rotates about an axis; and
a casing, wherein
the plurality of rotor blades are arranged in a circumferential direction about the axis and are attached to the rotor shaft so that the blade height direction is a radial direction with respect to the axis, and
the casing covers an outer peripheral side of the rotor shaft and the plurality of rotor blades.
